(19) United States
(12) Patent Application Publication
(10) Pub. No.: US 2021/0180161 A1
(43) Pub. Date: Jun. 17, 2021

(54) ALUMINUM ALLOY MATERIAL, AND BRAIDED SHIELD WIRE, ELECTROCONDUCTIVE MEMBER, MEMBER FOR CELL, FASTENING COMPONENT, COMPONENT FOR SPRING, COMPONENT FOR STRUCTURE, AND CABTIRE CABLE USING SAME

(71) Applicant: FURUKAWA ELECTRIC CO., LTD., Tokyo (JP)

(72) Inventors: Akiyoshi ARAKI, Tokyo (JP); Yoshiaki OGIWARA, Tokyo (JP)

(73) Assignee: FURUKAWA ELECTRIC CO., LTD., Tokyo (JP)

(21) Appl. No.: 17/269,872

(22) PCT Filed: Aug. 27, 2019
(86) PCT No.: PCT/JP2019/033455

§ 371 Date: Feb. 19, 2021

(30) Foreign Application Priority Data
Aug. 27, 2018 (JP) 2018-158089

(51) Int. Cl. C22C 21/08; C22C 21/02; H01B 1/02

(52) U.S. Cl. CPC C22C 21/08; H01B 1/023; C22C 21/02

(57) ABSTRACT

Provided is an aluminum alloy material having high strength and excellent wear resistance, which can be a substitute for an iron-based metal material or a copper-based metal material. The aluminum alloy material has an alloy composition containing 0.05-1.80% by mass of Mg, 0.01-2.00% by mass of Si, and 0.01-1.50% by mass of Fe, the remainder comprising Al and unavoidable impurities, wherein the aluminum alloy material has a fibrous microstructure in which crystal grains extend along substantially one direction, the average value of the short-direction dimension L2 perpendicular to the longitudinal direction of the crystal grains is 500 nm or less in a cross section parallel to the substantially one direction, and the arithmetic mean roughness Ra of a principal surface of the aluminum alloy material is no greater than 1.000 μm.

### TECHNICAL FIELD

The present invention relates to an aluminum alloy material, and particularly relates to an aluminum alloy material with excellent wear resistance. Such an aluminum alloy material is used in a wide range of application under repeated friction, such as a braided shield wire, a conductive member, a battery component, a fastening component, a spring component, a structural component, and a cabtire cable.

### BACKGROUND ART

Typically, a copper-based metal wire rod subjected to plating as necessary has been broadly used for a conductive member such as a conductor of a movable cable or a braided shield wire, such as an elevator cable, a robot cable, or a cabtire cable, for transmitting power or a signal. Recently, study has been conducted on substitution of the copper-based metal material for an aluminum-based material not only having a smaller specific weight and a higher thermal expansion coefficient than those of the copper-based metal material but also exhibiting relatively favorable electrical and heat conductivities and excellent corrosion resistance.

For the conductive member, there has been a demand that when, e.g., an elevator or a robot is operated or when an electrical product to which power is supplied through the cabtire cable is moved, the conductive member is not easily disconnected due to wear caused by contact between metal wire rods forming conductors or braided shield wires.

Recently, e.g., the technique of forming a three-dimensional structure by a method such as twisting, knitting, weaving, binding, joining, or connecting metal thin wires has been developed. For example, study on such a method has proceeded as Wire-Woven Cellular Materials, and such a method has been expected to be applied to a battery component, a heat sink, an impact absorption member, etc.

For a battery member of these components, study has been conducted on, e.g., a novel structure in which a clearance of a net-shaped electrode is filled with an active material. For avoiding disconnection due to expansion/contraction of the active material and external force during a manufacturing process, favorable strength properties and high wear resistance have been demanded.

For the fastening component, a material with high wear resistance has been also demanded. Recently, the materials of various cases or housings have been changed from typical iron-based materials to lightweight materials such as an aluminum alloy, a titanium alloy, a magnesium alloy, and plastic. This is because in a case where a housing made of these materials is fastened with the fastening component such as a screw, a bolt, a staple, or a binding wire, low wear resistance of the fastening component for the housing material is directly linked to fastening looseness. Moreover, a normal aluminum alloy is insufficient in strength, and for this reason, there has been a demand that the aluminum alloy has a proper strength.

In the case of, e.g., a compact precision coil spring, not only strength properties but also reduction in wear due to contact between winding wires upon contraction of the coil spring have been demanded for the spring component.

However, considering use of a pure aluminum material for these various components, there has been a problem that the pure aluminum material has lower wear resistance than those of the iron-based and copper-based metal materials. For example, for an application as a cable, the pure aluminum material does not withstand wear caused during operation, and the sectional area thereof decreases and electrical resistance thereof increases. Further, disconnection occurs.

Considering use of an aluminum alloy material for these various components, e.g., use of 2000-series (Al—Cu-based) or 7000-series (Al—Zn—Mg-based) aluminum alloy materials as aluminum alloy materials utilizing precipitation hardening and having relatively high fatigue resistance properties are conceivable. However, these aluminum alloy materials have problems such as poor electrical and heat conductivities, poor corrosion resistance, and poor stress corrosion crank resistance. Even in the case of using 6000-series (Al—Mg—Si-based) aluminum alloy materials having relatively excellent electrical and heat conductivities and corrosion resistance, these materials are still insufficient in wear resistance. For example, for an application as a cable, there has been a problem that electrical resistance increases due to wear when the cable is repeatedly deformed.

As the method for improving the wear resistance of the aluminum alloy material, a method in which a crystal matrix particle size of an aluminum parent phase is reduced in size and hard second phase particles (ceramics particles, Si particles) are dispersed has been proposed (Patent Documents 1 and 2). However, in this method, an additive element concentration is high, leading to a low mechanical strength and a low conductivity. For this reason, this method cannot be applied to the above-described applications, particularly applications as an electrical wire and a braided shield.

Patent Document 1: Japanese Unexamined Patent Application, Publication No. H08-120378

Patent Document 2: Japanese Unexamined Patent Application, Publication No. H05-222478

### DISCLOSURE OF THE INVENTION

### Problems to be Solved by the Invention

An object of the present invention is to provide an aluminum alloy material having high strength and high wear resistance and provide a braided shield wire, a conductive member, a battery member, a fastening component, a spring component, a structural component, and a cabtire cable using the aluminum alloy material.

### Means for Solving the Problems

As a result of intensive study, the inventor(s) of the present invention has found that an aluminum alloy material having a predetermined alloy composition, having a fibrous microstructure in which crystal grains extend in substantially one direction, and configured such that as viewed in a section parallel with the substantially one direction, the average value of the dimension (L2) of the crystal grain in a transverse direction perpendicular to a longitudinal direction of the crystal grain is 500 nm or less and the arithmetic average roughness Ra of a primary surface of the aluminum alloy material is 1.000 μm or less has both high strength and high wear resistance, and has arrived at the present invention based on such findings.

That is, the summary of the configuration of the present invention is as follows.

(1) An aluminum alloy material including an alloy composition containing 0.05% to 1.80% by mass of Mg, 0.01% to 2.00% by mass of Si, and 0.01% to 1.50% by mass of Fe and containing a remainder including Al and an inevitable impurity, the aluminum alloy material including a fibrous microstructure in which crystal grains extend in substantially one direction. The average value of the dimension (L2) of each crystal grain in a transverse direction perpendicular to a longitudinal direction of each crystal grain is 500 nm or less as viewed in a section parallel with the substantially one direction, and the arithmetic average roughness Ra of a primary surface of the aluminum alloy material is 1.000 μm or less.
(2) An aluminum alloy material including an alloy composition containing 0.05% to 1.80% by mass of Mg, 0.01% to 2.00% by mass of Si, and 0.01% to 1.50% by mass of Fe, containing a total of 2.00% by mass or less of one or more types selected from Cu, Ag, Zn, Ni, Ti, Co, Au, Mn, Cr, V, Zr, and Sn, and containing a remainder including Al and an inevitable impurity, the aluminum alloy material including a fibrous microstructure in which crystal grains extend in substantially one direction. The average value of the dimension (L2) of each crystal grain in a transverse direction perpendicular to a longitudinal direction of each crystal grain is 500 nm or less as viewed in a section parallel with the substantially one direction, and the arithmetic average roughness Ra of a primary surface of the aluminum alloy material is 1.000 μm or less.
(3) The aluminum alloy material according to (1) or (2), in which the aspect ratio (L1/L2) of the average value of the dimension (L1) of each crystal grain in a direction parallel with the longitudinal direction of each crystal grain to the average value of the transverse dimension (L2) of each crystal grain is 10 or greater as viewed in the section of the aluminum alloy material.
(4) The aluminum alloy material according to any one of (1) to (3), in which as viewed in the section of the aluminum alloy material, the average value of the longitudinal dimension (AL1) of each crystal grain present in a surface layer portion defined by a primary surface line of the aluminum alloy material and a 10-μm-depth line passing through a position away from the primary surface line in a depth direction by 10 μm is within a range of 1000 nm or greater and 500000 nm or less.
(5) The aluminum alloy material according to any one of (1) to (4), in which as viewed in the section of the aluminum alloy material, the average value of the longitudinal dimension (BL1) of each crystal grain present in a center portion about a thickness center line of the aluminum alloy material is within a range of 1500 nm or greater and 1000000 nm or less.
(6) The aluminum alloy material according to any one of (1) to (5), in which as viewed in the section of the aluminum alloy material, the ratio (BL1/AL1) of the average value of the longitudinal dimension (BL1) of each crystal grain present in the center portion about the thickness center line of the aluminum alloy material to the average value of the longitudinal dimension (AL1) of each crystal grain present in the surface layer portion defined by the primary surface line of the aluminum alloy material and the 10-μm-depth line passing through the position away from the primary surface line in the depth direction by 10 μm is within a range of 1.2 or greater and 4.0 or less.
(7) The aluminum alloy material according to any one of (1) to (6), in which the arithmetic average roughness Ra of the primary surface of the aluminum alloy material is 0.005 μm or greater.
(8) The aluminum alloy material according to any one of (1) to (7), in which the aluminum alloy material is a wire rod.
(9) The aluminum alloy material according to (8), in which the diameter of the wire rod is within a range of 0.01 mm to 0.65 mm.
(10) A braided shield wire using the aluminum alloy material according to any one of (1) to (9).
(11) A conductive member using the aluminum alloy material according to any one of (1) to (9).
(12) A battery member using the aluminum alloy material according to any one of (1) to (9).
(13) A fastening component using the aluminum alloy material according to any one of (1) to (9).
(14) A spring component using the aluminum alloy material according to any one of (1) to (9).
(15) A structural component using the aluminum alloy material according to any one of (1) to (9).
(16) A cabtire cable using the aluminum alloy material according to any one of (1) to (9).

### Effects of the Invention

According to the present invention, the aluminum alloy material has the predetermined alloy composition, has the fibrous microstructure in which the crystal grains extend in the substantially one direction, and is configured such that as viewed in the section parallel with the substantially one direction, the average value of the dimension (L2) of the crystal grain in the transverse direction perpendicular to the longitudinal direction is 500 nm or less and the arithmetic average roughness Ra of the primary surface of the aluminum alloy material is 1.000 μm or less. Thus, the aluminum alloy material having both high strength and high wear resistance is obtained, and the braided shield wire, the conductive member, the battery member, the fastening component, the spring component, the structural component, and the cabtire cable using the aluminum alloy material are obtained.

### BRIEF DESCRIPTION OF THE DRAWINGS

FIG. 1 shows a schematic perspective view of the state of a microstructure of an aluminum alloy material according to the present invention;

FIG. 2 shows a schematic sectional view of the section of the aluminum alloy material according to the present invention, the section being parallel with a crystal grain extending direction;

FIG. 3 shows an enlarged sectional view of a portion P forming a surface layer portion of the aluminum alloy material of FIG. 2;

FIG. 4 shows an SIM image of the state of a microstructure in the section of an aluminum alloy wire rod of Example 8 of the present invention, the section being parallel with a longitudinal direction of the aluminum alloy wire rod; and

FIG. 5A and FIG. 5B shows views for describing the method for measuring a dynamic friction coefficient and a wear amount of an aluminum-based wire rod as an example of the aluminum alloy material by a Bowden friction tester,

FIG. 5A showing a plan view of a relationship between the aluminum-based wire rod as a test object and a load tool and the load tool being indicated by a virtual line frame, and

FIG. 5B showing a sectional view along a D-D′ line of FIG. 5A.

### PREFERRED MODE FOR CARRYING OUT THE INVENTION

Hereinafter, a preferred embodiment of an aluminum alloy material of the present invention will be described in detail. The aluminum alloy material according to the present invention is an aluminum alloy material including an alloy composition containing 0.05% to 1.80% by mass of Mg, 0.01% to 2.00% by mass of Si, and 0.01% to 1.50% by mass of Fe, containing, as necessary, a total of 2.00% by mass or less of one or more types selected from Cu, Ag, Zn, Ni, Ti, Co, Au, Mn, Cr, V, Zr, and Sn, and containing a remainder including Al and inevitable impurities, the aluminum alloy material having a fibrous microstructure in which crystal grains extend in substantially one direction, the average value of the dimension (L2) of the crystal grain in a transverse direction perpendicular to a longitudinal direction of the crystal grain is 500 nm or less as viewed in a section parallel with the substantially one direction, and an arithmetic average roughness Ra of a primary surface of the aluminum alloy material being 1.000 μm or less.

In the present specification, the “crystal grain” indicates a portion surrounded by a misorientation boundary, and the “misorientation boundary” described herein indicates a boundary at which a contrast (a channeling contrast) discontinuously changes in a case where the microstructure is observed by using, e.g., a transmission electron microscope (TEM), a scanning transmission electron microscope (STEM), or a scanning ion microscope (SIM). Moreover, any of the dimension (also referred to as a longitudinal dimension (L1)) of the crystal grain in a direction parallel with the longitudinal direction and the dimension (also referred to as a transverse dimension (L2)) of the crystal grain in a direction perpendicular to the longitudinal direction corresponds to the interval of the misorientation boundary.

Further, the “primary surface” is a surface of the aluminum alloy material parallel with a processing direction (a stretching direction), and indicates a surface (hereinafter referred to as a processing surface) which directly contacts a tool (a rolling roll or a drawing die) and is subjected to stretching (thickness reduction). For example, the primary surface (the processing surface) in a case where the aluminum alloy material is a wire rod material is a surface (an outer peripheral surface) of the wire rod material parallel with a wire drawing direction (a longitudinal direction) thereof, and the primary surface (the processing surface) in a case where the aluminum alloy material is a plate material is a surface of the plate material contacting, e.g., the rolling roller among surfaces (two front and back surfaces) of the plate material parallel with a rolling direction thereof.

The processing direction described herein indicates a direction in which stretching progresses. For example, in a case where the aluminum alloy material is the wire rod material, the longitudinal direction (a direction perpendicular to a wire diameter) of the wire rod material corresponds to the wire drawing direction. Moreover, in a case where the aluminum alloy material is the plate material, a longitudinal direction of the plate material in a state in which rolling is performed corresponds to the rolling direction. Note that in the case of the plate material, the plate material might be cut into small pieces with a predetermined size after rolling. In this case, the longitudinal direction of the plate material after cutting is not necessarily coincident with the processing direction, but even in this case, the processing direction can be checked from a processing surface of the plate material.

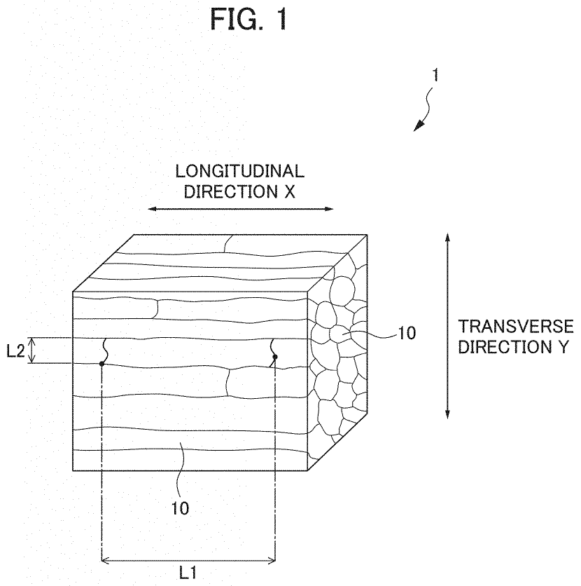

The aluminum alloy material according to the present invention has the fibrous microstructure in which the crystal grains extend in the substantially one direction. A schematic perspective view of the state of the microstructure of the aluminum alloy material according to the present invention is shown in FIG. 1. As shown in FIG. 1, the aluminum alloy material of the present invention has a fibrous structure in which the crystal grains 10 in an elongated shape extend in the substantially one direction. In FIG. 1, the crystal grains 10 extend in a longitudinal direction X. These crystal grains in the elongated shape are considerably different from typical fine crystal grains and flat crystal grains merely having a large aspect ratio. That is, the crystal grain of the present invention has a long and thin shape such as a fiber, and the average value of the transverse dimension (L2) of the crystal grain in a transverse direction Y perpendicular to the longitudinal direction X is 500 nm or less. The fibrous microstructure in which these fine crystal grains extend in the substantially one direction can be referred to as a novel microstructure not existing in a typical aluminum alloy material.

Further, the primary surface of the aluminum alloy material of the present invention has an arithmetic average roughness Ra of 1.000 μm or less. The aluminum alloy material having the above-described microstructure has high strength, and has a small contact area even if aluminum alloy materials contact each other. Further, the arithmetic average roughness Ra of the primary surface is set to a small value. Thus, even if the primary surfaces of the aluminum alloy materials relatively move in contact with each other, these primary surfaces are less shaved by surface roughness. Further, due to a synergy effect, wear particles formed due to wear are reduced in size. Thus, a lubrication effect upon contact between the aluminum alloy materials is enhanced. Thus, while a desired strength of the aluminum alloy material is maintained, wear resistance can be enhanced and disconnection due to wear can be reduced.

Size reduction of the crystal grain is directly linked not only to the function of reducing the contact area when the aluminum alloy materials contact each other, but also to the function of dispersing crystal slip to reduce a rough surface after plastic forming such as bending, the function of reducing sags or burrs upon shearing, and the function of improving grain boundary corrosion, for example. Thus, there is an effect of further improving the wear resistance.

### (1) Alloy Composition

The alloy composition of the aluminum alloy material of the present invention and the function thereof will be described. The aluminum alloy material of the present invention contains, as a basic composition, 0.05% to 1.80% by mass of Mg, 0.01% to 2.00% by mass of Si, and 0.01% to 1.50% by mass of Fe, and as necessary, contains a total of 2.00% by mass or less of one or more types selected from Cu, Ag, Zn, Ni, Ti, Co, Au, Mn, Cr, V, Zr, and Sn.

### <0.05% to 1.80% by Mass of Mg>

Magnesium (Mg) is an element contributing to a size reduction of a crystal grain of an aluminum base material and having the function of stabilizing fine crystal grains. For obtaining the above-described function and effect, a Mg content is 0.05% by mass or greater, preferably 0.10% by mass or greater, and more preferably 0.30% by mass or greater. However, a case where the Mg content exceeds 1.80% by mass is not preferred because a demerit of degraded strength and disconnection occurring is more apparent. Thus, the Mg content is 1.80% by mass or less, more preferably 1.50% by mass or less, and more preferably 1.00% by mass or less.

### <0.01% to 2.00% by Mass of Si>

Silicon (Si) is an element contributing to a size reduction of the crystal grain of the aluminum base material and having the function of stabilizing the fine crystal grains. For obtaining the above-described function and effect, a Si content is 0.01% by mass or greater, preferably 0.03% by mass or greater, and more preferably 0.10% by mass or greater. On the other hand, a case where the Si content exceeds 2.00% by mass is not preferred because the demerit of degraded strength and disconnection occurring is more apparent. Thus, the Si content is 2.00% by mass or less, more preferably 1.50% by mass or less, and more preferably 1.00% by mass or less.

### <0.01% to 1.50% by Mass of Fe>

Iron (Fe) is an element contributing to a formation of the fibrous crystal grain and size reduction of the crystal grain. For obtaining the above-described function and effect, an Fe content is 0.01% by mass or greater, preferably 0.05% by mass or greater, and more preferably 0.10% by mass or greater. On the other hand, if the Fe content exceeds 1.50% by mass, product crystallization increases, and the strength is degraded. The crystallized product described herein indicates an intermetallic compound generated during casting solidification of an alloy. Thus, the Fe content is 1.50% by mass or less, more preferably 1.00% by mass or less, and more preferably 0.80% by mass or less.

<Total of 0.00% to 2.00% by mass of One or More Types Selected from Group Consisting of Cu, Ag, Zn, Ni, Ti, Co, Au, Mn, Cr, V, Zr, and Sn>

Any of copper (Cu), silver (Ag), zinc (Zn), nickel (Ni), titanium (Ti), cobalt (Co), gold (Au), manganese (Mn), chromium (Cr), vanadium (V), zirconium (Zr), and tin (Sn) has the effect of reducing the crystal grain in size, and therefore, is an optional additive element component which can be added as necessary. These elements function synergistically with a later-described manufacturing method of the present invention, and effectively function for controlling the arithmetic average roughness Ra of the primary surface. The content of these optional additive element components is, for obtaining the above-described function and effect, 0.0001% by mass or greater in total, preferably 0.01% by mass or greater, more preferably 0.03% by mass or greater, and much more preferably 0.05% by mass or greater. On the other hand, if the total content of the optional additive element components exceeds 2.00% by mass, the strength is degraded, and disconnection easily occurs. Thus, in a case where one or more types selected from the group consisting of Cu, Ag, Zn, Ni, Ti, Co, Au, Mn, Cr, V, Zr, and Sn are contained, the total content thereof is preferably 2.00% by mass or less, more preferably 1.50% by mass or less, and much more preferably 1.00% by mass or less. In the case of further focusing on a conductivity, the total content is 0.50% by mass or less. Only one type of these optional additive element components may be contained alone, or a combination of two or more types of these optional additive element components may be contained. Note that the content of these optional additive element components or the lower limit thereof may be 0.00% by mass.

### <0.00% to 2.00% by Mass of Cu>

Cu is an element particularly having the function of improving heat resistance. For sufficiently fulfilling such a function, a Cu content is preferably 0.06% by mass or greater, and more preferably 0.30% by mass or greater. On the other hand, if the Cu content exceeds 2.00% by mass, workability is degraded, and corrosion resistance is degraded. Thus, the Cu content is preferably 2.00% by mass or less, more preferably 1.50% by mass or less, and much more preferably 1.20% by mass or less. Note that Cu is the optional additive element component, and therefore, in a case where Cu is not added, the lower limit of the Cu content is 0.00% by mass considering an impurity content.

### <0.00% to 2.00% by Mass of Ag>

Ag is an element particularly having the function of improving the heat resistance. For sufficiently fulfilling such a function, a Ag content is preferably 0.06% by mass or greater, and more preferably 0.30% by mass or greater. On the other hand, if the Ag content exceeds 2.00% by mass, the workability is degraded. Thus, the Ag content is preferably 2.00% by mass or less, more preferably 1.50% by mass or less, and much more preferably 1.20% by mass or less. Note that Ag is the optional additive element component, and therefore, in a case where Ag is not added, the lower limit of the Ag content is 0.00% by mass considering the impurity content.

### <0.00% to 2.00% by Mass of Zn>

Zn is an element particularly having the function of improving the heat resistance and the corrosion resistance in the case of use in a corrosive environment. For sufficiently fulfilling such a function, a Zn content is preferably 0.06% by mass or greater, and more preferably 0.30% by mass or greater. On the other hand, if the Zn content exceeds 2.00% by mass, the workability is degraded. Thus, the Zn content is preferably 2.00% by mass or less, more preferably 1.50% by mass or less, and much more preferably 1.20% by mass or less. Note that Zn is the optional additive element component, and therefore, in a case where Zn is not added, the lower limit of the Zn content is 0.00% by mass considering the impurity content.

### <0.00% to 2.00% by Mass of Ni>

Ni is an element particularly having the function of improving the heat resistance and the corrosion resistance in the case of use in the corrosive environment. In light of sufficiently fulfilling such a function, a Ni content is preferably 0.06% by mass or greater, and more preferably 0.30% by mass or greater. On the other hand, if the Ni content exceeds 2.00% by mass, the workability is degraded. Thus, the Ni content is preferably 2.00% by mass or less, more preferably 1.50% by mass or less, and much more preferably 1.20% by mass or less. Note that Ni is the optional additive element component, and therefore, in a case where Ni is not added, the lower limit of the Ni content is 0.00% by mass considering the impurity content.

### <0.000% to 2.000% by Mass of Ti>

Ti is an element having the function of reducing a crystal in size during casting, improving the heat resistance, and improving the corrosion resistance in the case of use in the corrosive environment. For sufficiently fulfilling the function of reducing the crystal in size during casting and improving the heat resistance, a Ti content is preferably 0.005% by mass or greater. In addition, for sufficiently fulfilling the function of improving the corrosion resistance in the case of use in the corrosive environment, the Ti content is preferably 0.06% by mass or greater, and more preferably 0.30% by mass or greater. On the other hand, if the Ti content exceeds 2.000% by mass, the workability is degraded. Thus, the Ti content is preferably 2.000% by mass or less, more preferably 1.500% by mass or less, and much more preferably 1.200% by mass or less. Note that Ti is the optional additive element component, and therefore, in a case where Ti is not added, the lower limit of the Ti content is 0.00% by mass considering the impurity content.

### <0.00% to 2.00% by Mass of Co>

Co is an element particularly having the function of improving the heat resistance and the corrosion resistance in the case of use in the corrosive environment. For sufficiently fulfilling such a function, a Co content is preferably 0.06% by mass or greater, and more preferably 0.30% by mass or greater. On the other hand, if the Co content exceeds 2.00% by mass, the workability is degraded. Thus, the Co content is preferably 2.00% by mass or less, more preferably 1.50% by mass or less, and much more preferably 1.20% by mass or less. Note that Co is the optional additive element component, and therefore, in a case where Co is not added, the lower limit of the Co content is 0.00% by mass considering the impurity content.

### <0.00% to 2.00% by Mass of Au>

Au is an element particularly having the function of improving the heat resistance. For sufficiently fulfilling such a function, a Au content is preferably 0.06% by mass or greater, and more preferably 0.30% by mass or greater. On the other hand, if the Au content exceeds 2.00% by mass, the workability is degraded. Thus, the Au content is preferably 2.00% by mass or less, more preferably 1.50% by mass or less, and much more preferably 1.20% by mass or less. Note that Au is the optional additive element component, and therefore, in a case where Au is not added, the lower limit of the Au content is 0.00% by mass considering the impurity content.

### <0.00% to 2.00% by Mass of Mn>

Mn is an element particularly having the function of improving the heat resistance and the corrosion resistance in the case of use in the corrosive environment. For sufficiently fulfilling such a function, a Mn content is preferably 0.06% by mass or greater, and more preferably 0.30% by mass or greater. On the other hand, if the Mn content exceeds 2.00% by mass, the workability is degraded. Thus, the Mn content is preferably 2.00% by mass or less, more preferably 1.50% by mass or less, and much more preferably 1.20% by mass or less. Note that Mn is the optional additive element component, and therefore, in a case where Mn is not added, the lower limit of the Mn content is 0.00% by mass considering the impurity content.

### <0.00% to 2.00% by Mass of Cr>

Cr is an element particularly having the function of improving the heat resistance and the corrosion resistance in the case of use in the corrosive environment. For sufficiently fulfilling such a function, a Cr content is preferably 0.06% by mass or greater, and more preferably 0.30% by mass or greater. On the other hand, if the Cr content exceeds 2.00% by mass, the workability is degraded. Thus, the Cr content is preferably 2.00% by mass or less, more preferably 1.50% by mass or less, and much more preferably 1.20% by mass or less. Note that Cr is the optional additive element component, and therefore, in a case where Cr is not added, the lower limit of the Cr content is 0.00% by mass considering the impurity content.

### <0.00% to 2.00% by Mass of V>

V is an element particularly having the function of improving the heat resistance and the corrosion resistance in the case of use in the corrosive environment. For sufficiently fulfilling such a function, a V content is preferably 0.06% by mass or greater, and more preferably 0.30% by mass or greater. On the other hand, if the V content exceeds 2.00% by mass, the workability is degraded. Thus, the V content is preferably 2.00% by mass or less, more preferably 1.50% by mass or less, and much more preferably 1.20% by mass or less. Note that V is the optional additive element component, and therefore, in a case where V is not added, the lower limit of the V content is 0.00% by mass considering the impurity content.

### <0.00% to 2.00% by Mass of Zr>

Zr is an element particularly having the function of improving the heat resistance and the corrosion resistance in the case of use in the corrosive environment. For sufficiently fulfilling such a function, a Zr content is preferably 0.06% by mass or greater, and more preferably 0.30% by mass or greater. On the other hand, if the Zr content exceeds 2.00% by mass, the workability is degraded. Thus, the Zr content is preferably 2.00% by mass or less, more preferably 1.50% by mass or less, and much more preferably 1.20% by mass or less. Note that Zr is the optional additive element component, and therefore, in a case where Zr is not added, the lower limit of the Zr content is 0.00% by mass considering the impurity content.

### <0.00% to 2.00% by Mass of Sn>

Sn is an element particularly having the function of improving the heat resistance and the corrosion resistance in the case of use in the corrosive environment. For sufficiently fulfilling such a function, a Sn content is preferably 0.06% by mass or greater, and more preferably 0.30% by mass or greater. On the other hand, if the Sn content exceeds 2.00% by mass, the workability is degraded. Thus, the Sn content is preferably 2.00% by mass or less, more preferably 1.50% by mass or less, and much more preferably 1.20% by mass or less. Note that Sn is the optional additive element component, and therefore, in a case where Sn is not added, the lower limit of the Sn content is 0.00% by mass considering the impurity content.

### <Remainder: Al and Inevitable Impurities>

A remainder other than the above-described components includes aluminum (Al) and the inevitable impurities. The inevitable impurities described herein mean impurities at a content which might be inevitably contained in a manufacturing process. The inevitable impurities might be a factor for degrading the conductivity depending on a content, and therefore, the content of the inevitable impurities is preferably suppressed to some extent, considering degradation of the conductivity. Examples of components as the inevitable impurities include bismuth (Bi), lead (Pb), gallium (Ga), and strontium (Sr). Note that the upper limit of the content of each of these components may be 0.03% by mass and the total amount of the above-described components may be 0.10% by mass.

Such an aluminum alloy material can be attained by control of the alloy composition and the manufacturing process in combination. Hereinafter, a preferred aluminum alloy material manufacturing method of the present invention will be described.

### (2) Aluminum Alloy Material Manufacturing Method According to One Example of Present Invention

A crystal grain boundary is, with a high density, introduced into, e.g., an Al—Mg—Si—Fe-based alloy, and in this manner, wear resistance of an aluminum alloy material according to one example of the present invention can be enhanced. By performing cold processing (stretching) for the aluminum alloy material, re-arrangement of a lattice defect in the alloy can be accelerated and can be stabilized. Thus, the crystal grain boundary can be introduced with the high density.

In the preferred aluminum alloy material manufacturing method of the present invention, the cold processing [1] is performed for the aluminum alloy material having the above-described predetermined alloy composition such that a final processing degree (a total processing degree) is 3.0 or greater. With a great total processing degree, metal crystal splitting accompanied by deformation of the microstructure can be accelerated, and the crystal grain boundary can be introduced into the aluminum alloy material with the high density. As a result, the strength of the aluminum alloy material is enhanced, and the wear resistance is considerably improved. Such a total processing degree is preferably 5.5 or greater, more preferably 6.5 or greater, much more preferably 7.5 or greater, and most preferably 8.5 or greater. Although not particularly specified, the upper limit of the total processing degree is normally 15.

Note that the processing degree η is represented by Expression (1) below when a sectional area before processing is s1 and a sectional area after processing is s2 (s1>s2).

Processing Degree (Non-Dimensional): η=1n(s1/s2) (1)

A cold processing method may be selected as necessary according to the shape (a wire rod material, a plate material, a strip, a foil, etc.) of a target aluminum alloy material and a desired surface roughness, and for example, may include a cassette roller die, groove roll rolling, round wire rolling, drawing with a die etc., and swaging. In any processing method, the crystal grain boundary is actively introduced into the aluminum alloy material, and the surface roughness is decreased according to processing conditions. Thus, high strength and excellent wear resistance are obtained. The above-described terms and conditions (the type of lubricant oil, a processing speed, processing heat generation, etc.) in processing may be adjusted as necessary within a well-known range.

The aluminum alloy material is not particularly limited as long as the aluminum alloy material has the above-described alloy composition, and for example, an extrusion material, an ingot material, a hot rolling material, or a cold rolling material can be selected as necessary according to the purpose of use.

As described above, in the present invention, processing with a high processing degree is performed for the aluminum alloy material by the method such as drawing with the die or rolling. As a result, the elongated aluminum alloy material is obtained. On the other hand, in a typical method for manufacturing aluminum alloy material such as powder sintering, compression twisting, high pressure torsion (HPT), forging, or equal channel angular pressing (ECAP), it is difficult to obtain such an elongated aluminum alloy material. Such an aluminum alloy material of the present invention is preferably manufactured with a length of 10 m or greater. Note that the upper limit of the length of the aluminum alloy material at the time of manufacturing is not particularly set, but is preferably 6000 m, considering the workability etc.

Moreover, it is effective to increase the processing degree of the aluminum alloy material of the present invention in order to reduce the crystal grain in size as described above. Thus, in a case where the aluminum alloy material of the present invention is produced particularly as the wire rod material, the configuration of the present invention is more easily attained with decreasing diameter. In a case where the aluminum alloy material of the present invention is produced as the plate member or the foil, the configuration of the present invention is more easily attained with increasing thickness.

Particularly, in a case where the aluminum alloy material of the present invention is the wire rod, the diameter thereof is preferably 0.65 mm or less, more preferably 0.40 mm or less, much more preferably 0.25 mm or less, and still much more preferably 0.15 mm or less. Note that although lower limit is not particularly set, the lower limit is preferably 0.01 mm, considering the workability etc. The wire rod made of the aluminum alloy of the present invention has high strength even if the wire rod is a thin wire, and therefore, one of advantages is that the wire rod can be used as a single thin wire. Another advantage of the aluminum alloy of the present invention is that wear due to contact between thin wires and disconnection due to such wear are less likely to occur when a plurality of wire rods is bundled and twisted.

In a case where the aluminum alloy material of the present invention is the plate material, the thickness thereof is preferably 2.0 mm or less, more preferably 1.0 mm or less, much more preferably 0.4 mm or less, and still much more preferably 0.2 mm or less. Note that although lower limit is not particularly set, the lower limit is preferably 0.01 mm. The plate material made of the aluminum alloy of the present invention has high strength even if the plate material is in the form of a thin plate or a foil, and therefore, one advantage is that the plate material can be used as a single thin layer.

The aluminum alloy material of the present invention is processed thinly as described above. However, a plurality of aluminum alloy materials is prepared and joined together to have a large thickness, and can be used for an intended application. Note that a well-known method can be used as a joining method, and examples thereof may include joining by pressure welding, welding, or an adhesive agent and friction stir joining. In a case where the aluminum alloy material is the wire rod material, a plurality of wire rod materials is bundled and twisted, and can be used as an aluminum alloy twisted wire for an intended application. Particularly, even in a case where the plurality of aluminum alloy materials of the present invention is joined together, wear due to contact therebetween is less likely to occur, and therefore, excellent durability is exhibited.

For the purpose of releasing residual stress or improving elongation, stabilization heat treatment [2] may be performed after the cold processing [1]. A treatment temperature of the stabilization heat treatment for the aluminum alloy material subjected to the cold processing is preferably 70° C. to 160° C. Moreover, retention time of the stabilization heat treatment is preferably 2 to 10 hours. In a case where the treatment temperature of the stabilization heat treatment is lower than 70° C. or a case where the retention time is shorter than 2 hours, the above-described functions are less likely to be obtained. In a case where the treatment temperature exceeds 160° C. or a case where the retention time exceeds 10 hours, the density of the crystal grain boundary tends to decrease due to growth of a metal crystal, and the strength tends to be degraded. Note that terms and conditions for the stabilization heat treatment can be adjusted as necessary according to the type and amount of inevitable impurity and a dissolution/deposition state of the aluminum alloy material. The stabilization heat treatment [2] is not necessarily performed, and in this case, an aluminum alloy material having a desired high strength and a desired high wear resistance can be also obtained.

### (3) Structural Characteristics of Aluminum Alloy Material of Present Invention

### <Microstructure>

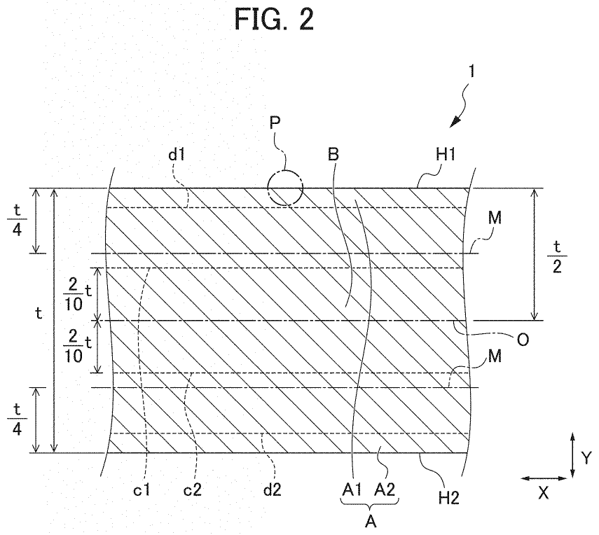

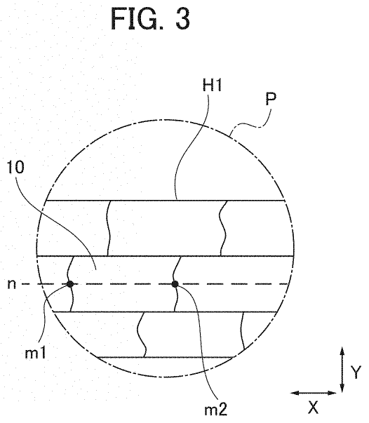

FIG. 2 shows a schematic sectional view of the section of the aluminum alloy material 1 according to the present invention, the section being parallel with the crystal grain extending direction. As in FIG. 1, FIG. 2 shows a case where the crystal grains extend in the longitudinal direction X. Moreover, FIG. 3 shows an enlarged sectional view of a portion P forming a surface layer portion A of the aluminum alloy material of FIG. 2.

In the aluminum alloy material of the present invention manufactured by the above-described manufacturing method, the crystal grain boundary is introduced into the microstructure with the high density. Such an aluminum alloy material of the present invention has the fibrous microstructure in which the crystal grains extend in the substantially one direction, and in the section of the aluminum alloy material parallel with the substantially one direction (the crystal grain extending direction), the average value of the dimension (the dimension L2 of FIG. 1) of the crystal grain in the transverse direction perpendicular to the longitudinal direction X is 500 nm or less in a region (more specifically, a region within 20% of the thickness t of the aluminum alloy material 1 along a thickness direction thereof from a middle line M at a position away from a primary surface line H1, H2 of the aluminum alloy material 1 toward a thickness center line O by ¼ of the thickness t as shown in FIG. 2) in the vicinity of the middle line M between the thickness center line and the primary surface line. Such an aluminum alloy material has the unique microstructure which is not typically provided, and therefore, high strength and excellent wear resistance can be particularly exhibited.

The microstructure of the aluminum alloy material of the present invention is the fibrous structure, and is in a state in which the crystal grains in the elongated shape extend in a fibrous shape in the substantially one direction.

The “one direction” in which the crystal grains extend as described herein is the longitudinal direction X of the crystal grain, and corresponds to the processing direction (the stretching direction) of the aluminum alloy material. For example, the “one direction” corresponds to the wire drawing direction in a case where the aluminum alloy material is the wire rod material, and corresponds to the rolling direction in a case where the aluminum alloy material is the plate material or the foil. The “one direction” preferably corresponds to the longitudinal direction of the aluminum alloy material. That is, in the aluminum alloy material, the stretching direction thereof normally corresponds to the longitudinal direction unless the aluminum alloy material is diced into a dimension shorter than a dimension in a direction perpendicular to the processing direction.

The state in which the crystal grains included in the fibrous microstructure “extend in the substantially one direction” indicates a state in which in the section of the aluminum alloy material 1 parallel with the direction in which the crystal grains extend, an angle between the longitudinal direction X of the crystal grain 10 and a direction parallel with the primary surfaces H1, H2 of the aluminum alloy material 1 is 0° or greater and 15° or less. For improvement in mechanical strength of the aluminum alloy material, such an angle is preferably 0° or greater and 10° or less, more preferably 0° or greater and 7° or less, and most preferably 0° or greater and 5% or less. The longitudinal direction X of the crystal grain can be referred to as the direction of a line n passing through a midpoint m1 in the transverse direction Y at a left end of the crystal grain 10 and a midpoint m2 in the transverse direction Y at a right end of the crystal grain 10, as shown in FIG. 3.

In the section of the aluminum alloy material parallel with the above-described substantially one direction, the average value of the transverse dimension (L2) of the crystal grain is 500 nm or less, preferably 400 nm or less, more preferably 350 nm or less, much more preferably 300 nm or less, and still much more preferably 200 nm or less. In the fibrous microstructure in which the thin crystal grains with such a diameter (the transverse dimension (L2) of the crystal grain) extend in the substantially one direction, the crystal grain boundary is formed with the high density. According to such a microstructure, crystal slip accompanied by deformation can be effectively inhibited. Moreover, by the lubrication effect provided by size reduction of a wear piece, high strength and high wear resistance which cannot be typically attained can be attained. The aluminum alloy material can be stronger. Due to a lower likelihood of contact leading to wear occurring, the wear resistance can also be enhanced. A smallest possible average value of the transverse dimension (L2) of the crystal grain is preferred for attaining high strength and high wear resistance, but the lower limit thereof as a manufacturing or physical limit is 500 nm, for example.

Although not particularly specified, the average value of the longitudinal dimension (L1) of the crystal grain is preferably 1200 nm or greater, more preferably 1700 nm or greater, and much more preferably 2200 nm or greater. Considering the ranges of the average value of the longitudinal dimension (L1) and the average value of the transverse dimension (L2) as described above, the aspect ratio (L1/L2) of the average value of the longitudinal dimension (L1) of the crystal grain to the average value of the transverse dimension (L2) of the crystal grain is preferably 10 or greater, and more preferably 20 or greater.

In the section of the aluminum alloy material 1 shown in FIG. 2, the average value of the longitudinal dimension (AL1) of the crystal grain present in the surface layer portion A in the vicinity of the primary surface (the primary surface line H1, H2) and the average value of the longitudinal dimension (BL1) of the crystal grain present in a center portion B about the thickness center line O are preferably different from each other. With this configuration, the aluminum alloy material 1 has, between each of the primary surfaces H1, H2 and the thickness center line O, the microstructure with the gradient of the dimension of the crystal grain in the longitudinal direction X, and therefore, the novel microstructure not existing in the typical aluminum alloy material can be obtained.

The surface layer portion A described herein is, as viewed in the section of the aluminum alloy material 1 parallel with the crystal grain extending direction as shown in FIG. 2, a region defined by the primary surface line H1, H2 of the aluminum alloy material 1 and a 10-μm-depth line d1, d2 passing through a position away from the primary surface line H1, H2 in a depth direction (the thickness direction of the aluminum alloy material) by 10 μm. The center portion B is, as viewed in the above-described section, a region about the thickness center line O set such that a distance to the primary surface H1 of the aluminum alloy material 1 and a distance to the primary surface H2 are equal to each other in the thickness direction of the aluminum alloy material 1, and is a region extending to positions (thickness lines c1, c2 of FIG. 2) away from the thickness center line O to both sides thereof in the thickness direction of the aluminum alloy material 1 by 2/10 of the thickness t. In a case where the aluminum alloy material is the wire rod, the thickness t is equivalent to the diameter of the wire rod, and the center portion B is defined by the lines (the thickness lines c1, c2 of FIG. 2) passing through the positions away from the thickness center line O in a wire diameter direction by 2/10 of the wire diameter (the thickness t).

Particularly, in the above-described section as shown in FIG. 2, the average value of the longitudinal dimension (AL1) of the crystal grain present in the surface layer portion A is preferably 1000 nm or greater and 500000 nm or less, and more preferably 2000 nm or greater and 100000 nm or less. The average value of the longitudinal dimension (AL1) of the crystal grain present in the surface layer portion A is within the above-described range. Thus, the arithmetic average roughness Ra of the primary surface H1, H2 of the aluminum alloy material 1 is easily controlled within a range of 1.000 μm or less, and therefore, the wear resistance of the aluminum alloy material can be improved.

Moreover, in the above-described section as shown in FIG. 2, the average value of the longitudinal dimension (BL1) of the crystal grain present in the center portion B is preferably 1500 nm or greater and 1000000 nm or less, and more preferably 3000 nm or greater and 100000 nm or less. The average value of (BL1) of the crystal grain present in the center portion B is within the above-described range, and therefore, the mechanical strength of the aluminum alloy material can be improved.

Moreover, in the above-described section as shown in FIG. 2, the ratio (BL1/AL1) of the average value of the longitudinal dimension (BL1) of the crystal grain present in the center portion B to the average value of the longitudinal dimension (AL1) of the crystal grain present in the surface layer portion A is preferably 1.2 or greater and 4.0 or less, more preferably 1.5 or greater and 3.5 or less, much more preferably 1.8 or greater and 3.0 or less, and still much more preferably 2.1 or greater and 2.5 or less. With this configuration, the wear resistance and mechanical strength of the aluminum alloy material can both be improved.

As described above, in the aluminum alloy material 1, the average value of the longitudinal dimension (BL1) of the crystal grain present in the center portion B is preferably greater than the average value of the longitudinal dimension (AL1) of the crystal grain present in the surface layer portion A, and in this case, the aluminum alloy material 1 has such a gradient that the average value of the longitudinal dimension (L1) of the crystal grain decreases from the thickness center line O toward the primary surface line H1, H2.

As in the above-described aspect ratio (L1/L2), each of the aspect ratio (AL1/AL2) of the average value of the longitudinal dimension (AL1) of the crystal grain to the average value of the transverse dimension (AL2) of the crystal grain in the surface layer portion A and the aspect ratio (BL1/BL2) of the average value of the longitudinal dimension (BL1) of the crystal grain to the average value of the transverse dimension (BL2) of the crystal grain in the center portion B is preferably 10 or greater, and more preferably 20 or greater.

Observation of such a fibrous microstructure can be performed using, e.g., the transmission electron microscope (TEM), the scanning transmission electron microscope (STEM), or the scanning ion microscope (SIM). Of these microscopes, the scanning ion microscope (SIM) is preferably used for performing observation. In the present embodiment, the longitudinal direction (the wire drawing direction) of the aluminum alloy material can be approximated to the crystal grain extending direction (the longitudinal direction X). In this case, one finished by ion milling with a focused ion beam (FIB) in the section of the aluminum alloy material parallel with the wire drawing direction can be an observation sample.

In SIM observation, a gray contrast is preferably used. In this case, a difference in the contrast is taken as a difference in a crystal orientation, and a boundary at which the contrast is discontinuously different can be recognized as the crystal grain boundary. Note that depending on the depth of entrance of the ion beam, there might be no difference in the gray contrast even in the case of different crystal orientations. In this case, an angle between the electron beam and the sample is changed while the sample is inclined by ±3° to ±6° about two sample rotation axes perpendicular to each other in a sample stage of the scanning ion microscope, and an observation surface is photographed under a plurality of ion entrance depth conditions. In this manner, the grain boundary is recognized.

For example, during SIM observation of the middle line M and the vicinity thereof, the field of view for observation is (15 to 40) μm in length×(15 to 40) μm in width. In the section parallel with the crystal grain extending direction (the longitudinal direction X) as shown in FIG. 2, the position (a position away from the primary surface H1, H2 of the aluminum alloy material 1 toward the thickness center line O by ¼ of the thickness t) at which the distance between the thickness center line O and the primary surface line H1 and the distance between the thickness center line O and the primary surface line H2 are equal to each other in the transverse direction Y (the direction perpendicular to the longitudinal direction X) is taken as the middle line M, and observation is performed in the region within 20% of the thickness t from the middle line M along the thickness direction of the aluminum alloy material. Of the observed crystal grains, an arbitrary 100 crystal grains are selected. The longitudinal dimension L1 of each crystal grain in the longitudinal direction X (the substantially one direction in which the crystal grains extend) and the transverse dimension L2 of each crystal grain in the transverse direction Y are measured, and the average value of these dimensions L1, L2 is calculated.

During SIM observation of a surface layer portion A1 of the surface layer portion A on a primary surface line H1 side, the field of view for observation is 10 μm in length×1000 μm in width. In the section parallel with the longitudinal direction X of the crystal grain as shown in FIG. 2, a line passing through a position away from the primary surface line H1 of the aluminum alloy material 1 in the depth direction (the thickness direction of the aluminum alloy material) by 5 μm is taken as a center, and observation is performed for a region from such a center line to positions away from the center line toward both sides thereof along the depth direction by 5 μm. With this configuration, observation can be performed for the region defined by the primary surface line H1 and the 10-μm-depth line d1 passing through the position away from the primary surface line H1 in the depth direction by 10 μm. Similarly, during SIM observation of a surface layer portion A2 of the surface layer portion A on a primary surface line H2 side, a line passing through a position away from the primary surface line H2 in the depth direction by 5 μm is taken as a center, and observation is performed for a region from such a center line to positions away from the center line toward both sides thereof along the depth direction by 5 μm. Of the crystal grains observed as described above, an arbitrary 100 crystal grains are selected. The longitudinal dimension AL1 of each crystal grain in the longitudinal direction X (the direction in which the crystal grains extend) and the transverse dimension AL2 of each crystal grain in the transverse direction Y are measured, and the average value of these dimensions AL1, AL2 is calculated.

During SIM observation of the center portion B, the field of view for observation is 10 μm in length×1000 μm in width. In the section parallel with the longitudinal direction X of the crystal grain as shown in FIG. 2, observation is performed for the region about the thickness center line O at which the distance to the primary surface line H1 of the aluminum alloy material 1 and the distance to the primary surface line H2 are equal to each other in the thickness direction of the aluminum alloy material 1. More specifically, observation is performed within the region defined by the lines (the thickness lines c1, c2 of FIG. 2) passing through the positions away from the thickness center line O to both sides thereof in the thickness direction of the aluminum alloy material by 2/10 of the thickness t. Of the observed crystal grains, an arbitrary 100 crystal grains are selected. The longitudinal dimension BL1 of each crystal grain in the longitudinal direction X (the direction in which the crystal grains extend) and the transverse dimension BL2 of each crystal grain in the transverse direction Y are measured, and the average value of these dimensions BL1, BL2 is calculated. Moreover, the BL1/AL1 ratio is calculated from the average value of the longitudinal dimension AL1 and the average value of the longitudinal dimension BL1.

During observation of the fibrous microstructure with the scanning ion microscope (SIM), if the percentage of the area of the fibrous microstructure (a) in the captured image is 20° or greater, the above-described effect of improving the mechanical strength and wear resistance of the aluminum alloy material is easily produced. For easy enhancement of the strength and wear resistance of the aluminum alloy material, the area percentage (a) is preferably 50% or greater, more preferably 60% or greater, much more preferably 70% or greater, and still much more preferably 80% or greater.

### <Surface Properties>

The aluminum alloy material of the present invention manufactured by the above-described manufacturing method has a primary surface arithmetic average roughness Ra of 1.000 μm or less. Such an aluminum alloy material is combined with the fine crystal structure which is not typically provided. Thus, while having a desired strength, the aluminum alloy material fulfills the function of reducing the wear particles formed due to wear in size to enhance the lubrication effect and the function of suppressing shaving of the primary surfaces of the aluminum alloy materials by the surface roughness when these primary surfaces relatively move in contact with each other. Consequently, the aluminum alloy material can particularly exhibit excellent wear resistance. Moreover, the arithmetic average roughness Ra of the primary surface of the aluminum alloy material of the present invention is preferably 0.800 μm or less, more preferably 0.500 μm or less, much more preferably 0.300 μm or less, still much more preferably 0.100 μm or less, and still much more preferably 0.050 μm or less. On the other hand, for reduction in a manufacturing cost and proper accuracy of a measurement apparatus, the arithmetic average roughness Ra of the primary surface of the aluminum alloy material of the present invention may be preferably 0.005 μm or greater, and more preferably 0.01 μm or greater.

### (4) Properties of Aluminum Alloy Material of Present Invention

### [Dynamic Friction Coefficient and Wear Amount]

A dynamic friction coefficient and a wear amount are values measured using a Bowden friction tester. Specific measurement conditions will be described in a later-described example section. The aluminum alloy material of the present invention preferably has a dynamic friction coefficient of 0.80 or less. With such a dynamic friction coefficient, wear of the aluminum alloy material is less likely to occur even if the same type of material or other types of material contact the aluminum alloy material. Thus, in a case where the aluminum alloy wire rod material of the present invention is, for example, applied to braided shield wires of a cable, even if friction is caused between the braided shield wires due to bending of the cable, wear of these wires can be reduced. Thus, the effect of extending the life of the cable is produced. Moreover, the dynamic friction coefficient of the present invention is more preferably 0.70 or less, and much more preferably 0.60 or less.

The wear amount of the aluminum alloy material of the present invention in a test using the Bowden friction tester is preferably 100 μm or less, more preferably 80 μm or less, and much more preferably 60 μm or less.

[Covering with Other Metals]

The aluminum alloy material of the present invention may be used not only as a bare material, but also may be covered with other metals by a method such as plating or cladding. The covering metals include, for example, Cu, Ni, Ag, Pd, Au, and Sn producing effects such as reduction in contact resistance and improvement of the corrosion resistance. A coverage with the other metals is preferably up to about 25% of the total area of the section of the aluminum alloy material perpendicular to the longitudinal direction. This is because an extremely high coverage degrades a weight reduction effect. The above-described coverage is preferably 15% or less, more preferably 10% or less, and much more preferably 5% or less. In the case of performing plastic forming after metal covering, the covering metal and the aluminum alloy as the base material might react with each other due to heat generation due to processing, leading to formation of the intermetallic compound. Thus, a method such as reduction in a wire drawing speed to 50 m/min or less or enhancement of the capacity of forcibly cooling a lubricant agent to cool a processing target material is necessary.

### (5) Application of Aluminum Alloy Material of Present Invention

The aluminum alloy material of the present invention may be targeted for any application using an iron-based material, a copper-based material, and an aluminum-based material. Particularly, the aluminum alloy material of the present invention combines high strength and high wear resistance. Thus, the plurality of aluminum alloy materials is preferably bundled and twisted, and as the aluminum alloy twisted wire, is preferably used for an intended application. Specifically, the aluminum alloy material can be suitably used as a conductive member such as an electrical wire, a braided shield wire, or a cable, a battery member such as a mesh or a net for a current collector, a fastening component such as a screw, a bolt, or a rivet, a spring component such as a coil spring, an electrical contact spring member such as a connector or a terminal, a structural component such as a shaft or a frame, a guide wire, a bonding wire for a semiconductor, or a winding wire used in a power generator or a motor. Of these applications, more specific application examples of the conductive member include a power wire such as an overhead transmission line, an OPGW, an underground electrical wire, and an underwater cable, a communication electrical wire such as a telephone cable or a coaxial cable, an equipment electrical wire such as a wired drone cable, a cabtire cable, an EV/HEV charging cable, a twisted cable for offshore wind power generation, an elevator cable, an umbilical cable, a robot cable, a train cable, or a trolley wire, a transportation electrical wire such as an automobile wire harness, a marine electrical wire, or an airplane electrical wire, a bus bar, a lead frame, a flexible flat cable, a conductor rod, an antenna, a connector, a terminal, and a cable braid. Particularly, in the case of use as a twisted wire in an electrical wire or a cable, the aluminum alloy of the present invention and a versatile copper or aluminum conductor may be combined and used as the twisted wire. The battery member includes, for example, an electrode of a solar battery and an electrode of a lithium-ion battery. More specific application examples of the structural component (member) include a scaffold in a construction site, a conveyor mesh belt, a metal fiber for clothing, a chain mail, a fence, an insect repellent net, a zipper, a fastener, a clip, aluminum wool, a bicycle component such as a brake wire or a spoke, a reinforcement wire for reinforced glass, a pipe seal, metal packing, a protection reinforcement material for a cable, a core metal for a fan belt, a wire for driving an actuator, a chain, a hanger, a mesh for soundproofing, and a shelf. More specific application examples of the fastening component (member) include a set screw, a staple, and a pushpin. More specific application examples of the spring component (member) include a spring electrode, a terminal, a connector, a spring for a semiconductor probe, a plate spring, and a power spring. Moreover, the aluminum alloy material is also suitable as a metal fiber added to impart electrical conductivity to a resin-based material, a plastic material, cloth, etc. or to control a strength or an elastic modulus. In addition, the aluminum alloy material is also suitable as a commercial member or a medical member such as an eyeglass frame, a watch belt, a pen point of a fountain pen, a fork, a helmet, or an injection needle.

The embodiment of the present invention has been described above, but the present invention is not limited to the above-described embodiment. The present invention includes any aspect included in the concept and claims of the present invention, and various modifications can be made within the scope of the present invention.

### EXAMPLES

Next, for further clarifying the effects of the present invention, examples of the present invention and comparative examples will be described, but the present invention is not limited to these examples.

### Examples 1 to 28 of Present Invention

First, each rod material of 10 mmϕ was prepared, the rod material having an alloy composition shown in Table 1. Next, each aluminum alloy wire rod was produced using each rod material under manufacturing conditions shown in Table 2.

In Examples 1 to 9 of the present invention, the processing degree in wire drawing and a wire drawing condition were changed for the aluminum alloy wire rods having the same composition, and the transverse dimension (L2) of the crystal grain and the arithmetic average roughness Ra of the primary surface were adjusted. More specifically, the processing degree in wire drawing was changed such that the transverse dimension (L2) of the crystal grain is adjusted. Moreover, the transverse dimension (L2) of the crystal grain was adjusted or the wire drawing condition was changed such that the arithmetic average roughness Ra of the primary surface is adjusted.

In each of Examples 10 to 11, 12 to 13, 14 to 17, and 18 to 19 of the present invention, the composition of the aluminum alloy wire rod was adjusted or the wire drawing condition was changed such that the arithmetic average roughness Ra of the primary surface is adjusted.

Note that alphabets A to G for overall manufacturing conditions and numbers 1 to 4 for a condition (the wire drawing condition) for a die used for wire drawing shown in Table 2 are specifically as follows.

### <Manufacturing Condition A>

Wire drawing was performed for the prepared rod material such that the total processing degree reached 5.5, and the stabilization heat treatment was subsequently performed by holding the rod material at 100° C. for five hours.

### <Manufacturing Condition B>

Wire drawing was performed for the prepared rod material such that the total processing degree reached 6.5, and the stabilization heat treatment was subsequently performed by holding the rod material at 100° C. for five hours.

### <Manufacturing Condition C>

Wire drawing was performed for the prepared rod material such that the total processing degree reached 7.5, and the stabilization heat treatment was subsequently performed by holding the rod material at 100° C. for five hours.

### <Manufacturing Condition D>

Wire drawing was performed for the prepared rod material such that the total processing degree reached 8.5, and the stabilization heat treatment was subsequently performed by holding the rod material at 100° C. for five hours.

### <Manufacturing Condition E>

Wire drawing was performed for the prepared rod material such that the total processing degree reached 2.0, and the stabilization heat treatment was subsequently performed by holding the rod material at 100° C. for five hours.

### <Manufacturing Condition F>

After wire drawing had been performed such that the total processing degree reached 7.5, temper annealing was performed at 200° C. to make the fibrous microstructure disappear.

### <Manufacturing Condition G>

After wire drawing had been performed such that the total processing degree reached 7.5, temper annealing was performed at 300° C. to make the fibrous microstructure disappear.

### <Wire Drawing Condition 1>

After wire drawing had been performed by means of a die using a tip made of natural diamond, wire drawing using a natural diamond die with fine steps was performed, as a finishing process.

### <Wire Drawing Condition 2>

Wire drawing was performed by means of the die using the tip made of the natural diamond.

### <Wire Drawing Condition 3>

Wire drawing was performed by means of a die using a tip made of sintered diamond.

### <Wire Drawing Condition 4>

Wire drawing was performed by means of a die using a tip made of cemented carbide.

### Comparative Examples 1, 2

In Comparative Examples 1 and 2, the wire drawing condition was adjusted using a rod material of 10 mmϕ, the rod material having an alloy composition of Table 1. In this manner, an aluminum-based wire rod having a primary surface arithmetic average roughness Ra of greater than 1.000 μm was produced.

### Comparative Examples 3, 4

In Comparative Examples 3 and 4, the processing degree in wire drawing with the die was adjusted using a rod material of 10 mmϕ, the rod material having an alloy composition of Table 1. In this manner, an aluminum-based wire rod having a crystal grain transverse dimension average value of greater than 500 nm was produced.

### Comparative Example 5

In Comparative Example 5, wire drawing using the die was performed using a rod material of 10 mmϕ, the rod material having an alloy composition containing neither Mg nor Si as shown in Table 1. In this manner, an aluminum-based wire rod having a crystal grain transverse dimension average value of greater than 500 nm was produced.

### Comparative Example 6

In Comparative Example 6, wire drawing using the die was performed using a rod material of 10 mmϕ, the rod material having an alloy composition not containing Fe as shown in Table 1. In this manner, an aluminum-based wire rod not having fibrous microstructure and having a crystal grain transverse dimension average value of greater than 500 nm was produced.

### Comparative Example 7

In Comparative Example 7, wire drawing using the die was performed using a rod material of 10 mmϕ, the rod material having an alloy composition shown in Table 1. Thereafter, an aluminum-based wire rod in which a fibrous microstructure had been eliminated by temper annealing at 300° C. was produced.

### Comparative Example 8

In Comparative Example 8, an aluminum-based wire rod was produced in such a manner that wire drawing using the die was performed using a rod material of 10 mmϕ, the rod material containing Fe of greater than 1.50% by mass as shown in Table 1.

### Comparative Example 9

In Comparative Example 9, an aluminum-based wire rod was produced in such a manner that wire drawing using the die was performed using a rod material of 10 mmϕ, the rod material containing Mg of greater than 1.80% by mass and Si of greater than 2.00% by mass as shown in Table 1.

### Comparative Example 10

In Comparative Example 10, an aluminum-based wire rod was produced in such a manner that wire drawing using the die was performed using a rod material of 10 mmϕ, the rod material containing Cu and Cr of greater than 2.00% by mass in total as shown in Table 1.

### Typical Example 1

In Typical Example 1, wire drawing using the die was performed using a rod material of 10 mmϕ, the rod material containing pure copper. Thereafter, a copper wire rod with an equiaxial microstructure was produced by temper annealing at 200° C.

### [Evaluation]

Property evaluation as described below was performed using the aluminum-based wire rods according to the examples of the present invention, the comparative examples, and the typical example described above. Evaluation conditions for each property are as follows. Results are shown in Table 1 and Table 2. Note that the aluminum-based wire rods of Comparative Examples 8 to 10 were disconnected during wire drawing, and for this reason, the properties thereof were not evaluated.

### [1] Alloy Composition

An emission spectroscopic analysis method was performed according to JIS H1305:2005. Note that measurement was performed using an emission spectroscopic analysis apparatus (manufactured by Hitachi High-Tech Science Corporation).

### [2] Structure Observation

Scanning ion microscope (SIM) observation of the microstructure was performed using a scanning ion microscope (SMI3050 TB manufactured by Seiko Instruments Inc.). Observation was performed at an acceleration voltage of 30 kV. As the observation sample, one finished by ion milling with a focused ion beam (FIB) in the section of the wire rod parallel with a longitudinal direction (a wire drawing direction) thereof was used. In SIM observation, the gray contrast was used, the difference in the contrast was taken as the difference in the crystal orientation, and the boundary at which the contrast is discontinuously different was recognized as the crystal grain boundary. Note that depending on the conditions for the depth of entrance of the ion beam, there might be no difference in the gray contrast even in the case of different crystal orientations. In this case, the angle between the electron beam and the sample was changed while the sample was inclined by ±3% to ±6% about two sample rotation axes perpendicular to each other in the sample stage of the scanning ion microscope, and the observation surface was photographed under the plurality of ion entrance depth conditions. In this manner, the grain boundary was recognized.

(1) Measurement of Average Crystal Particle Diameter near Middle Line M and Evaluation on Fibrous Structure

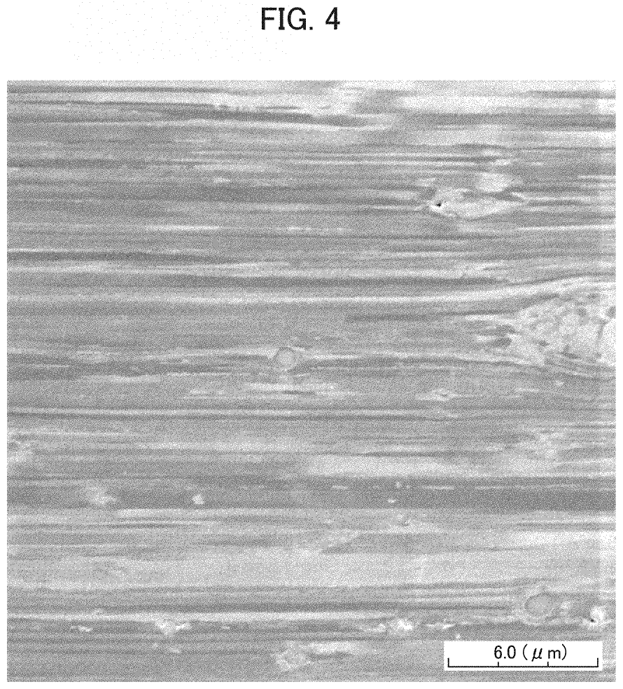

The field of view for SIM observation was (15 to 40) μm×(15 to 40) μm. In the above-described section, observation was performed at the position (the region within 20% of the thickness t along the wire diameter direction (the thickness direction of the aluminum alloy material) from the middle line M at the position away from a primary surface line side of the wire rod toward a thickness center line side by ¼ of the wire diameter (the thickness t)) in the vicinity of the middle between the thickness center line at the center and the primary surface line forming the surface layer on the line corresponding to the wire diameter direction (the direction perpendicular to the longitudinal direction). The field of view for observation was adjusted as necessary according to the size of the crystal grain. From the image captured during SIM observation, the presence or absence of the fibrous microstructure in the section of the wire rod parallel with the longitudinal direction (the wire drawing direction) was determined. FIG. 4 shows part of a TEM image of the section, which is parallel with the longitudinal direction (the wire drawing direction), of the wire rod of Example 8 of the present invention, the TEM image being captured during SIM observation. In the examples of the present invention, in a case where the microstructure as shown in FIG. 4 was observed, the fibrous microstructure was evaluated as “present”. In each field of view for observation, an arbitrary 100 crystal grains of the crystal grains were selected. The longitudinal dimension (L1) of each crystal grain parallel with the longitudinal direction X (the substantially one direction in which the crystal grains extend) and the transverse dimension (L2) of each crystal grain in the transverse direction Y perpendicular to the longitudinal direction X were measured. Then, an average value for 100 crystal grains was calculated, and the aspect ratio (L1/L2) of the crystal grain was obtained from such an average value. Note that in some comparative examples, the average particle size of the observed crystal grain was obviously greater than 500 nm, and therefore, the number of crystal grains to be selected for measurement of each dimension was decreased and the average value thereof was calculated. Moreover, those with a crystal grain longitudinal dimension (L1) which is obviously ten times as great as the crystal grain transverse dimension (L2) or greater were, without exception, determined as those with an aspect ratio of 10 or greater. From the image captured during SIM observation in the field of view for observation in the vicinity of the middle line M, the percentage of the area of the fibrous microstructure (a) was obtained.

### (2) Measurement of Longitudinal Dimension (AL1) of Crystal Grain Present in Surface Layer Portion A

The field of view for SIM observation was 10 μm×1000 μm. The line passing through the position away from the primary surface line H1, H2 of the aluminum alloy material 1 in the depth direction (the thickness direction of the aluminum alloy material) by 5 μm was taken as the center, and SIM observation was performed for the region from such a center line to the positions away from the center line toward both sides thereof along the depth direction by 5 μm. Of the observed crystal grains, an arbitrary 100 crystal grains were selected, and the average value of the longitudinal dimension AL1 of each crystal grain parallel with the longitudinal direction (the substantially one direction in which the crystal grains extend) was calculated.

### (3) Measurement of Longitudinal Dimension (BL1) of Crystal Grain Present in Center Portion B

The field of view for SIM observation was 10 μm×1000 μm, and the thickness center line O at which the distance to the primary surface line H1 of the aluminum alloy material 1 and the distance to the primary surface line H2 are equal to each other in the thickness direction of the aluminum alloy material 1 was obtained. Then, SIM observation was performed within the region from the thickness center line O to the positions away from the thickness center line O to both sides thereof in the thickness direction of the aluminum alloy material by 2/10 of the thickness. Of the observed crystal grains, an arbitrary 100 crystal grains were selected, and the average value of the longitudinal dimension BL1 of each crystal grain parallel with the longitudinal direction (the substantially one direction in which the crystal grains extend) was calculated. Moreover, the ratio AL1/BL1 of the average value of the longitudinal dimension AL1 to the average value of the longitudinal dimension BL1 was calculated.

### [3] Surface Property Evaluation

A laser microscope (VK-8500 manufactured by Keyence Corporation) was used for measurement of the arithmetic average roughness Ra of the primary surface of the aluminum-based wire rod, and the arithmetic average roughness (Ra) according to ISO standards (ISO 25178) was measured. Depending on the diameter of the aluminum-based wire rod and the surface roughness of the primary surface, a magnification was selected as necessary from 100 times, 300 times, and 1000 times and a cutoff value was selected as necessary from 80 μm, 250 μm, and 800 μm as laser microscope measurement conditions. During measurement, a rectangular region with 20 μm in a circumferential direction×30 μm to 100 μm in a longitudinal direction was irradiated with laser. The arithmetic average roughness was similarly measured for an arbitrary ten locations, and the average value (N=10) thereof was taken as the arithmetic average roughness Ra of the primary surface in the present test. Results are shown in Table 2.

### [4] Property Evaluation

The dynamic friction coefficient and wear amount of the aluminum-based wire rod were measured using the Bowden friction tester. As a partner material to be slid on each of the aluminum-based wire rods of Examples 1 to 28 of the present invention, Comparative Examples 1 to 10, and Typical Example 1, the same one as the aluminum-based wire rod as a test object was used. The dynamic friction coefficient and wear amount of the surface of the aluminum-based wire rod were specifically measured as follows.

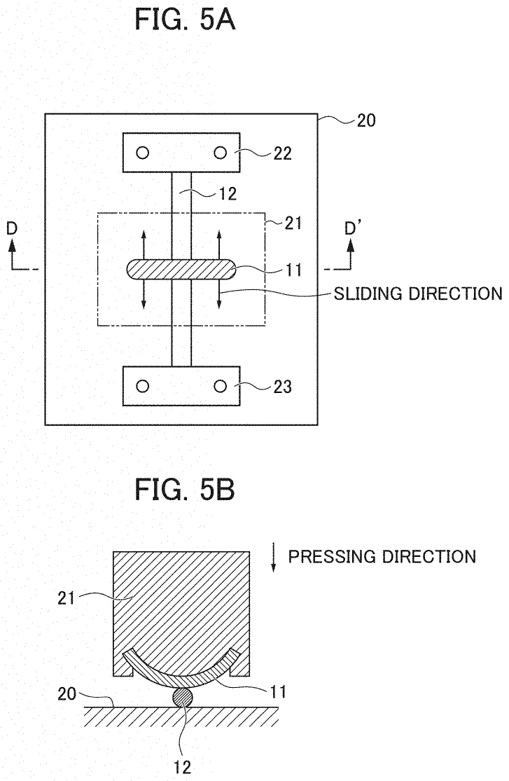

FIG. 5A and FIG. 5B shows views for describing the method for measuring the dynamic friction coefficient and wear amount of the aluminum-based wire rod as an example of the aluminum alloy material by the Bowden friction tester. Of these views, FIG. 5A shows a plan view of a relationship between the aluminum-based wire rod as the test object and a load tool, and the load tool is indicated by a virtual line frame. Moreover, FIG. 5B shows a sectional view along a D-D′ line of FIG. 5A.

As shown in FIG. 5A, a first test object 11 which is one of the aluminum-based wire rods as the test objects was fixed to a load tool 21 such that a lower side of the first test object 11 was raised. Moreover, as shown in FIG. 5B, a second test object 12 which is the other aluminum-based wire rod was fixed to a mounting table 20 with fixing tools 22, 23. Subsequently, a raised portion of the first test object 11 contacted a surface of the second test object 12 such that the longitudinal directions of the wire rods cross perpendicularly to each other. While a load of 0.78 N (80 gf) was being applied, the first test object 11 and the second test object 12 relatively moved a sliding distance of 10 mm and reciprocally slid 100 times. A sliding speed in this case was 100 mm/min. The average values of the dynamic friction coefficients and wear amounts of the first test object 11 and the second test object 12 after completion of sliding were taken as the dynamic friction coefficient and wear amount of the aluminum-based wire rod in the present test. Results are shown in Table 2.

TABLE 1

| | | Alloy Composition [% by mass] | | | | | | | |
|---|---|---|---|---|---|---|---|---|---|
| | | | | | One or More Elements Selected from Cu, Ag, Zn, Ni, | | | | Al and |
| | | | | | Ti, Co, Au, Mn, Cr, V, Zr, and Sn | | | | Inevitable |
| | | Mg | Si | Fe | Component 1 | Component 2 | Component 3 | Total Content | Impurities |
| Examples | 1 | 0.50 | 0.60 | 0.22 | — | — | — | — | Remainder |
| | 2 | 0.50 | 0.60 | 0.22 | — | — | — | — | Remainder |
| | 3 | 0.50 | 0.60 | 0.22 | — | — | — | — | Remainder |
| | 4 | 0.50 | 0.60 | 0.22 | — | — | — | — | Remainder |
| | 5 | 0.50 | 0.60 | 0.22 | — | — | — | — | Remainder |
| | 6 | 0.50 | 0.60 | 0.22 | — | — | — | — | Remainder |
| | 7 | 0.50 | 0.60 | 0.22 | — | — | — | — | Remainder |
| | 8 | 0.50 | 0.60 | 0.22 | — | — | — | — | Remainder |
| | 9 | 0.50 | 0.60 | 0.22 | — | — | — | — | Remainder |
| | 10 | 0.50 | 0.60 | 0.35 | — | — | — | — | Remainder |
| | 11 | 0.50 | 0.60 | 0.35 | — | — | — | — | Remainder |
| | 12 | 0.52 | 0.55 | 0.70 | — | — | — | — | Remainder |
| | 13 | 0.52 | 0.55 | 0.70 | — | — | — | — | Remainder |
| | 14 | 0.10 | 0.04 | 0.18 | Cu = 0.22 | — | — | 0.22 | Remainder |
| | 15 | 0.10 | 0.04 | 0.18 | Cu = 0.22 | — | — | 0.22 | Remainder |
| | 16 | 0.10 | 0.04 | 0.18 | Cu = 0.22 | — | — | 0.22 | Remainder |
| | 17 | 0.10 | 0.04 | 0.18 | Cu = 0.22 | — | — | 0.22 | Remainder |
| | 18 | 0.06 | 0.21 | 0.33 | — | — | — | — | Remainder |
| | 19 | 0.06 | 0.21 | 0.33 | — | — | — | — | Remainder |
| | 20 | 0.52 | 0.48 | 0.19 | Ni = 0.05 | Cr = 0.05 | Ag = 0.21 | 0.31 | Remainder |
| | 21 | 0.52 | 0.48 | 0.19 | Mn = 0.05 | Au = 0.05 | Ti = 0.010 | 0.11 | Remainder |
| | 22 | 0.52 | 0.48 | 0.19 | Mn = 0.05 | Ag = 0.21 | — | 0.26 | Remainder |
| | 23 | 0.52 | 0.48 | 0.19 | Zr = 0.05 | V = 0.05 | Co = 0.21 | 0.31 | Remainder |
| | 24 | 0.52 | 0.48 | 0.19 | Mn = 0.05 | Zn = 0.01 | — | 0.06 | Remainder |
| | 25 | 0.29 | 0.29 | 0.19 | — | — | — | — | Remainder |
| | 26 | 0.98 | 0.53 | 0.02 | Cu = 0.28 | Cr = 0 .17 | — | 0.45 | Remainder |
| | 27 | 1.80 | 1.70 | 0.50 | — | — | — | — | Remainder |
| | 28 | 0.63 | 0.66 | 0.13 | Ag = 0.05 | Cu = 0.10 | — | 0.15 | Remainder |
| Comparative | 1 | 0.50 | 0.60 | 0.22 | — | — | — | — | Remainder |
| Examples | 2 | 0.63 | 0.66 | 0.13 | Ag = 0.05 | Cu = 0.10 | — | 0.15 | Remainder |
| | 3 | 0.50 | 0.60 | 0.22 | — | — | — | — | Remainder |
| | 4 | 0.29 | 0.29 | 0.19 | — | — | — | — | Remainder |
| | 5 | 0.00 | 0.00 | 0.20 | — | — | — | — | Remainder |
| | 6 | 0.54 | 0.58 | 0.00 | — | — | — | — | Remainder |
| | 7 | 0.60 | 0.30 | 0.05 | — | — | — | — | Remainder |
| | 8 | 1.80 | 1.70 | 1.70 | — | — | — | — | Remainder |
| | 9 | 2.30 | 2.50 | 0.40 | Ni = 0.20 | — | — | 0.20 | Remainder |
| | 10 | 0.50 | 0.60 | 0.22 | Cu = 1.85 | Cr = 0.35 | — | 2.20 | Remainder |

| | | |
|---|---|---|
| Typical | 1 | Pure Copper Material |
| Example | | |

Notes:
Underlines in the table indicate those outside proper ranges oh the present invention.

TABLE 2

| | | | | | Structure Evaluation | | | |
|---|---|---|---|---|---|---|---|---|
| | | | | | | Average | | Average |
| | | | | | | Value of | | Value of |
| | | Manufacturing | | | | Transverse | | Longitudinal |
| | | Condition | | | | Dimension | | Dimension |
| | | | Condition | | Presence or | (L2) of | | (AL1) of |
| | | | for Die | Wire | Absence of | Crystal | Aspect | Crystal |
| | | | Used for | Diameter | Fibrous | Grain | Ratio | Grain |
| | | Overall | Drawing | [mm] | Microstructure | [nm] | (L1/L2 ) | [nm] |
| Examples | 1 | A | 1 | 0.64 | Present | 230 | ≥10 | 220000 |
| | 2 | A | 2 | 0.64 | Present | 230 | ≥10 | 180000 |
| | 3 | A | 3 | 0.64 | Present | 230 | ≥10 | 130000 |
| | 4 | B | 1 | 0.39 | Present | 150 | ≥10 | 98000 |
| | 5 | B | 2 | 0.39 | Present | 150 | ≥10 | 75000 |
| | 6 | C | 1 | 0.24 | Present | 110 | ≥10 | 35000 |
| | 7 | C | 2 | 0.24 | Present | 110 | ≥10 | 27000 |
| | 8 | D | 1 | 0.14 | Present | 140 | ≥10 | 15000 |
| | 9 | D | 2 | 0.14 | Present | 140 | ≥10 | 13000 |
| | 10 | D | 1 | 0.14 | Present | 140 | ≥10 | 9200 |
| | 11 | D | 2 | 0.14 | Present | 140 | ≥10 | 6800 |
| | 12 | D | 1 | 0.14 | Present | 110 | ≥10 | 1200 |
| | 13 | D | 2 | 0.14 | Present | 110 | ≥10 | 1100 |
| | 14 | D | 1 | 0.14 | Present | 320 | ≥10 | 130000 |
| | 15 | D | 2 | 0.14 | Present | 320 | ≥10 | 110000 |
| | 16 | D | 3 | 0.14 | Present | 320 | ≥10 | 90000 |
| | 17 | D | 4 | 0.14 | Present | 320 | ≥10 | 80000 |
| | 18 | D | 1 | 0.14 | Present | 470 | ≥10 | 450000 |
| | 19 | D | 2 | 0.14 | Present | 470 | ≥10 | 370000 |
| | 20 | D | 1 | 0.14 | Present | 150 | ≥10 | 3700 |
| | 21 | D | 1 | 0.14 | Present | 150 | ≥10 | 6700 |
| | 22 | D | 1 | 0.14 | Present | 150 | ≥10 | 5800 |
| | 23 | D | 1 | 0.14 | Present | 150 | ≥10 | 9500 |
| | 24 | B | 1 | 0.39 | Present | 190 | ≥10 | 8900 |
| | 25 | D | 1 | 0.14 | Present | 210 | ≥10 | 11000 |
| | 26 | B | 1 | 0.39 | Present | 380 | ≥10 | 150000 |
| | 27 | D | 1 | 0.14 | Present | 80 | ≥10 | 1000 |
| | 28 | D | 1 | 0.14 | Present | 120 | ≥10 | 11000 |
| Comparative | 1 | C | 4 | 0.24 | Present | 260 | ≥10 | 78000 |
| Examples | 2 | D | 4 | 0.14 | Present | 160 | ≥10 | 75000 |
| | 3 | E | 1 | 3.68 | Present | 530 | ≥10 | 120000 |
| | 4 | E | 2 | 3.68 | Present | 820 | ≥10 | 210000 |
| | 5 | C | 2 | 0.2 | Present | 1100 | 7 | 29000 |
| | 6 | B | 3 | 0.39 | Absent | 640 | 7 | 520 |
| | 7 | G | 2 | 0.24 | Absent | 1500 | 2 | 1300 |
| | 8 | A | 3 | 0.64 | Disconnection occurred | | | |
| | 9 | A | 3 | 0.64 | Disconnection occurred | | | |
| | 10 | A | 3 | 0.64 | Disconnection occurred | | | |
| Typical | 1 | F | 1 | 0.24 | Absent | 20000 | 1 | 19000 |
| Example | | | | | | | | |

| | | Structure Evaluation | | | | | |
|---|---|---|---|---|---|---|---|
| | | Average | | | Surface | | |
| | | Value of | | | Property | | |
| | | Longitudinal | | Percentge | Evaluation | | |
| | | Dimension | | of Area of | Arithmetic | Property | |
| | | (BL1) of | | Fibrous | Average | Evaluation | |
| | | Crystal | | Microstructure | Roughness | Dynamic | Wear |
| | | Grain | BL1/AL1 | (a) | Ra | Friction | Amount |
| | | [nm] | Ratio | [%] | [μm] | Coefficient | [μm] |
| Examples | 1 | 850000 | 3.9 | 62 | 0.022 | 0.50 | 20 |
| | 2 | 590000 | 3.3 | 65 | 0.114 | 0.55 | 46 |
| | 3 | 380000 | 2.9 | 63 | 0.351 | 0.60 | 51 |
| | 4 | 210000 | 2.1 | 76 | 0.052 | 0.47 | 37 |
| | 5 | 140000 | 1.9 | 85 | 0.142 | 0.55 | 44 |
| | 6 | 69000 | 2.0 | 88 | 0.024 | 0.45 | 25 |
| | 7 | 48000 | 1.8 | 84 | 0.332 | 0.46 | 41 |
| | 8 | 27000 | 1.8 | 91 | 0.015 | 0.47 | 33 |
| | 9 | 22000 | 1.7 | 94 | 0.229 | 0.51 | 42 |
| | 10 | 16000 | 1.7 | 93 | 0.053 | 0.44 | 33 |
| | 11 | 11000 | 1.6 | 90 | 0.551 | 0.46 | 45 |
| | 12 | 1800 | 1.5 | 79 | 0.085 | 0.45 | 38 |
| | 13 | 1500 | 1.4 | 74 | 0.834 | 0.52 | 38 |
| | 14 | 290000 | 2.2 | 88 | 0.013 | 0.40 | 30 |
| | 15 | 240000 | 2.2 | 85 | 0.123 | 0.52 | 45 |
| | 16 | 200000 | 2.2 | 86 | 0.451 | 0.57 | 41 |
| | 17 | 170000 | 2.1 | 89 | 0.887 | 0.65 | 55 |
| | 18 | 970000 | 2.2 | 91 | 0.047 | 0.55 | 40 |
| | 19 | 850000 | 2.3 | 95 | 0.441 | 0.69 | 58 |
| | 20 | 7000 | 1.9 | 83 | 0.042 | 0.39 | 32 |
| | 21 | 11000 | 1.6 | 90 | 0.062 | 0.42 | 28 |
| | 22 | 12000 | 2.1 | 94 | 0.080 | 0.48 | 39 |
| | 23 | 18000 | 1.9 | 92 | 0.054 | 0.45 | 33 |
| | 24 | 19000 | 2.1 | 70 | 0.022 | 0.51 | 28 |
| | 25 | 21000 | 1.9 | 84 | 0.012 | 0.62 | 40 |
| | 26 | 320000 | 2.1 | 98 | 0.030 | 0.65 | 44 |
| | 27 | 1200 | 1.2 | 71 | 0.011 | 0.36 | 22 |
| | 28 | 19000 | 1.7 | 88 | 0.004 | 0.38 | 35 |
| Comparative | 1 | 95000 | 1.2 | 84 | 1.221 | 1.12 | 140 |
| Examples | 2 | 85000 | 1.1 | 82 | 1.323 | 0.95 | 140 |
| | 3 | 140000 | 1.2 | 59 | 0.043 | 0.85 | 180 |
| | 4 | 180000 | 0.9 | 51 | 0.231 | 1.13 | 250 |
| | 5 | 51000 | 1.6 | 48 | 0.237 | 0.98 | 300 |
| | 6 | 980 | 1.9 | 0 | 0.758 | 0.95 | 210 |
| | 7 | 2500 | 1.9 | 0 | 0.552 | 1.40 | 300 |
| | 8 | Disconnection occurred | | | | | |
| | 9 | Disconnection occurred | | | | | |
| | 10 | Disconnection occurred | | | | | |
| Typical | 1 | 21000 | 1.1 | | 0.04 | 1.20 | 180 |
| Example | | | | | | | |

Notes:
Underlines in the table indicate those outside proper ranges of the present invention and those that the evaluation results do not pass passing levels in the examples of the present invention.

The evaluation results of Table 1 and Table 2 have showed that in the aluminum alloy wire rods of Examples 1 to 28 of the present invention, the alloy compositions were within the proper ranges of the present invention, the fibrous microstructures each having the crystal grains extend in the substantially one direction were provided, the average value of the transverse dimension (L2) of the crystal grain was 500 nm or less, and the aspect ratio (L1/L2) of the longitudinal dimension (L1) to the transverse dimension (L2) of the crystal grain was 10 or greater. FIG. 4 shows the SIM image of the section of the aluminum alloy wire rod according to Example 8 of the present invention, the section being parallel with the wire drawing direction. Note that the microstructures similar to that of FIG. 4 were also confirmed in the sections, which are parallel with the longitudinal direction, of the aluminum alloy wire rods according to Examples 1 to 7 and 9 to 28 of the present invention.

The aluminum alloy wire rods according to Examples 1 to 28 of the present invention had these unique microstructures, and had a primary surface arithmetic average roughness Ra of 1.000 μm or less. Any of these aluminum alloy wire rods had a dynamic friction coefficient of 0.80 or less and a wear amount of 100 μm or less. Moreover, no disconnection was confirmed in these aluminum alloy wire rods.

In addition, in the aluminum alloy wire rods of Examples 1 to 28 of the present invention, the average value of the longitudinal dimension (AL1) of the crystal grain present in the surface layer portion defined by the primary surface line of the aluminum alloy material and the 10-μm-depth line passing through the position away from the primary surface line in the depth direction by 10 μm was within a range of 1000 nm or greater and 500000 nm or less. Moreover, for the aluminum alloy wire rods of Examples 1 to 28 of the present invention, it has been confirmed that the ratio (AL1/BL1) of the average value of the longitudinal dimension (AL1) to the average value of the longitudinal dimension (BL1) was within a range of 1.2 or greater and 4.0 or less. For the aluminum alloy wire rods of Examples 1 to 26 and 28 of the present invention among these aluminum alloy wire rods, it has been confirmed that the average value of the longitudinal dimension (BL1) of the crystal grain present in the center portion about the thickness center line of the aluminum alloy material was within a range of 1500 nm or greater and 1000000 nm or less.

In addition, in any of the aluminum alloy wire rods of Examples 1 to 28 of the present invention, the percentage of the area of the fibrous microstructure (a) in the image captured during SIM observation in the vicinity of the middle line M was 20% or greater.

On the other hand, in the aluminum alloy wire rods of Comparative Examples 1 and 2, the primary surface arithmetic average roughness Ra exceeded 1.000 μm. For this reason, these aluminum alloy wire rods did not pass the passing level in terms of a high dynamic friction coefficient and a great wear amount. In the aluminum alloy wire rods of Comparative Examples 3 and 4, the average value of the transverse dimension (L2) of the crystal grain exceeded 500 nm. For this reason, these aluminum alloy wire rods did not pass the passing level in terms of a high dynamic friction coefficient and a great wear amount. The aluminum alloy wire rod of Comparative Example 5 did not contain Mg and Si, and in such a wire rod, the average value of the transverse dimension (L2) of the crystal grain exceeded 500 nm. For this reason, such an aluminum alloy wire rod did not pass the passing level in terms of a high dynamic friction coefficient and a great wear amount. The aluminum alloy wire rod of Comparative Example 6 did not contain Fe and did not have the fibrous microstructure, and in such a wire rod, the average value of the transverse dimension (L2) of the crystal grain exceeded 500 nm. For this reason, such an aluminum alloy wire rod did not pass the passing level in terms of a high dynamic friction coefficient and a great wear amount. The aluminum alloy wire rod of Comparative Example 7 did not have the fibrous microstructure, and in such a wire rod, the average value of the transverse dimension (L2) of the crystal grain exceeded 500 nm. For this reason, such an aluminum alloy wire rod did not pass the passing level in terms of a high dynamic friction coefficient and a great wear amount. In the aluminum alloy wire rod of Comparative Example 8, the Fe content exceeded the proper range of the present invention. For this reason, the strength was degraded, and disconnection occurred. In the aluminum alloy wire rod of Comparative Example 9, the Mg and Si contents exceeded the proper ranges of the present invention. For this reason, the strength was degraded, and disconnection occurred. In the aluminum alloy wire rod of Comparative Example 10, the total of the Cu and Cr contents exceeded the proper range of the present invention. For this reason, the strength was degraded, and disconnection occurred. The pure copper of Typical Example 1 did not have the fibrous microstructure, and in such pure copper, the average value of the transverse dimension (L2) of the crystal grain exceeded 500 nm. For this reason, such pure copper did not pass the passing level in terms of a high dynamic friction coefficient and a great wear amount.

### EXPLANATION OF REFERENCE NUMERALS

1 Aluminum Alloy Material
10 Crystal Grain
11 First Test Object
12 Second Test Object
20 Mounting Table
21 Load Tool
22, 23 Fixing Tool
L1 Longitudinal Dimension
L2 Transverse Dimension
A, A1, A2 Surface Layer Portion
B Center Portion
M Middle Line
O Thickness Center Line
H1, H2 Primary Surface Line
c1, c2 Thickness Line
d1, d2 10-μm-Depth Line
m1, m2 Midpoint
X Longitudinal Direction of Crystal Grain
Y Transverse Direction of Crystal Grain

1. An aluminum alloy material, comprising 0.05% to 1.80% by mass of Mg, 0.01% to 2.00% by mass of Si, and 0.01% to 1.50% by mass of Fe and comprising a remainder including Al and an inevitable impurity,
wherein the aluminum alloy material has a fibrous microstructure of crystal grains which extend in substantially one direction,
wherein an average value of a dimension (L2) of each crystal grain in a transverse direction perpendicular to a longitudinal direction of each crystal grain is 500 nm or less as viewed in a section parallel with the substantially one direction, and
wherein an arithmetic average roughness Ra of a primary surface of the aluminum alloy material is 1.000 μm or less.

2. An aluminum alloy material, comprising 0.05% to 1.80% by mass of Mg, 0.01% to 2.00% by mass of Si, 0.01% to 1.50% by mass of Fe, a total of 2.00% by mass or less of at least one selected from the group consisting of Cu, Ag, Zn, Ni, Ti, Co, Au, Mn, Cr, V, Zr, and Sn, and comprising a remainder including Al and an inevitable impurity,
wherein the aluminum alloy material has a fibrous microstructure of crystal grains which extend in substantially one direction,
wherein an average value of a dimension (L2) of each crystal grain in a transverse direction perpendicular to a longitudinal direction of each crystal grain is 500 nm or less as viewed in a section parallel with the substantially one direction, and
wherein an arithmetic average roughness Ra of a primary surface of the aluminum alloy material is 1.000 μm or less.

3. The aluminum alloy material of claim 1, wherein an aspect ratio (L1/L2) of an average value of a dimension (L1) of each crystal grain in a direction parallel with the longitudinal direction of each crystal grain to the average value of the transverse dimension (L2) of each crystal grain is 10 or greater as viewed in the section of the aluminum alloy material.

4. The aluminum alloy material of claim 1, wherein as viewed in the section of the aluminum alloy material, an average value of a longitudinal dimension (AL1) of each crystal grain present in a surface layer portion defined by a primary surface line of the aluminum alloy material and a 10-μm-depth line passing through a position away from the primary surface line in a depth direction by 10 μm is within a range of 1000 nm or greater and 500000 nm or less.

5. The aluminum alloy material of claim 1, wherein as viewed in the section of the aluminum alloy material, an average value of a longitudinal dimension (BL1) of each crystal grain present in a center portion about a thickness center line of the aluminum alloy material is within a range of 1500 nm or greater and 1000000 nm or less.

6. The aluminum alloy material of claim 1, wherein as viewed in the section of the aluminum alloy material, a ratio (BL1/AL1) of the average value of the longitudinal dimension (BL1) of each crystal grain present in the center portion about the thickness center line of the aluminum alloy material to the average value of the longitudinal dimension (AL1) of each crystal grain present in the surface layer portion defined by the primary surface line of the aluminum alloy material and the 10-μm-depth line passing through the position away from the primary surface line in the depth direction by 10 μm is within a range of 1.2 or greater and 4.0 or less.

7. The aluminum alloy material of claim 1, wherein the arithmetic average roughness Ra of the primary surface of the aluminum alloy material is 0.005 μm or greater.

8. The aluminum alloy material of claim 1, wherein the aluminum alloy material is a wire rod.

9. The aluminum alloy material according to claim 8, wherein a diameter of the wire rod is within a range of 0.01 mm to 0.65 mm.

10. A braided shield wire, comprising the aluminum alloy material of claim 1.

11. A conductive member, comprising the aluminum alloy material of claim 1.

12. A battery member, comprising the aluminum alloy material of claim 1.

13. A fastening member, comprising the aluminum alloy material of claim 1.

14. A spring component, comprising the aluminum alloy material of claim 1.

15. A structural component, comprising the aluminum alloy material of claim 1.

16. A cabtire cable, comprising the aluminum alloy material of claim 1.
